(19) United States
(12) Patent Application Publication
(10) Pub. No.: US 2017/0048451 A1
(43) Pub. Date: Feb. 16, 2017

(54) METHOD AND APPARATUS FOR CONTROLLING VIDEO IMAGE

(71) Applicant: Xiaomi Inc., Beijing (CN)

(72) Inventors: Qiang FU, Beijing (CN); Yang WANG, Beijing (CN); Enxing HOU, Beijing (CN)

(73) Assignee: Xiaomi Inc.

(21) Appl. No.: 15/232,908

(22) Filed: Aug. 10, 2016

(30) Foreign Application Priority Data
Aug. 11, 2015 (CN) 201510491289.6

(51) Int. Cl. H04N 5/232; G06F 3/0488; H04N 7/18; G06F 3/0484

(52) U.S. Cl. CPC H04N 5/23216; H04N 5/23206; G06F 3/04847; G06F 3/0488; H04N 7/183; H04N 5/2253

(57) ABSTRACT

The present disclosure refers to a method and an apparatus for controlling a video image. The method can be applied on a smart terminal associated with a smart photographic device. The method includes: detecting whether a predetermined rotating instruction is received, when displaying a first video image taken by the smart photographic device; sending the predetermined rotating instruction to the smart photographic device, if the predetermined rotating instruction is detected; displaying a second video image photographed by the smart photographic device after the smart photographic device is rotated according to the predetermined rotating instruction.

### CROSS-REFERENCE TO RELATED APPLICATIONS

This application is based on and claims priority to Chinese Patent Application Serial No. 201510491289.6, filed with the State Intellectual Property Office of P. R. China on Aug. 11, 2015, the entire content of which is incorporated herein by reference.

### TECHNICAL FIELD

The present disclosure generally relates to communication technology field and, more particularly, to a method and an apparatus for controlling a video image.

### BACKGROUND

Presently, after a smart phone and its associated smart photographic device are connected to a network, video images photographed by the smart photographic device are displayed in real time via the smart phone. However, the range of a video image is limited because of the limitation of the shooting-angle of the smart photographic device.

### SUMMARY

According to a first aspect of embodiments of the present disclosure, there is provided a method for controlling a video image, applied on a smart terminal associated with a smart photographic device, including: detecting whether a predetermined rotating instruction is received, when displaying a first video image photographed by the smart photographic device; sending the predetermined rotating instruction to the smart photographic device, if the predetermined rotating instruction is detected; and displaying a second video image photographed by the smart photographic device after the smart photographic device is rotated according to the predetermined rotating instruction.

According to a second aspect of embodiments of the present disclosure, there is provided a method for controlling a video image, applied on a smart photographic device, the smart photographic device including a cradle head and a camera, the method including: receiving a rotating instruction sent from a smart terminal; and controlling the cradle head to drive the camera to rotate according to the rotating instruction, photographing a video image after rotating the camera, and returning the video image to the smart terminal.

According to a third aspect of embodiments of the present disclosure, there is provided an apparatus for controlling a video image, applied on a smart terminal associated with a smart photographic device, including: a processor; and a memory for storing instructions executable by the processor. The processor, when executing the instructions stored in the memory, is configured to: detect whether a predetermined rotating instruction is received, when displaying a first video image photographed by the smart photographic device; send the predetermined rotating instruction to the smart photographic device, if the predetermined rotating instruction is detected; and display a second video image photographed by the smart photographic device after the smart photographic device is rotated according to the predetermined rotating instruction.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A is a flow chart showing a method for controlling a video image, according to an example embodiment.

FIG. 1B is a schematic diagram showing a common application scene, according to an example embodiment.

FIG. 1C is a schematic diagram showing a smart terminal displaying a video image, according to an example embodiment.

FIG. 2A is a flow chart showing another method for controlling a video image, according to an example embodiment.

FIG. 2B is a schematic diagram showing another smart terminal displaying a video image, according to an example embodiment.

FIG. 3 is a flow chart showing a method for controlling a video image, according to an example embodiment.

FIGS. 4-10 are block diagrams each showing an apparatus for controlling a video image, according to an example embodiment.

FIG. 11 is a block diagram of a device for controlling a video image, according to an example embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The terms used in the present disclosure are only for purpose of description of specific embodiments, but not constructed to limit the present disclosure. The singular forms such as “a/an”, “the” used in the present disclosure and the appended claims also include plural forms unless otherwise distinctly represented in the contexts. It also should be noted that, the term “and/or” used herein means any one of associated listed items or all combinations thereof.

It should be noted that, although the terms the first, the second, the third to describe various information, the information should not be limited to these terms. These terms are only for distinguish the same kind of information. For instance, the first information may also be referred as the second information, and similarly, the second information may also be referred as the first information, without departing from the scope of the present disclosure. Depending on the contexts, the word “if” used herein may also be interpreted as “during” or “when” or “responding determining”.

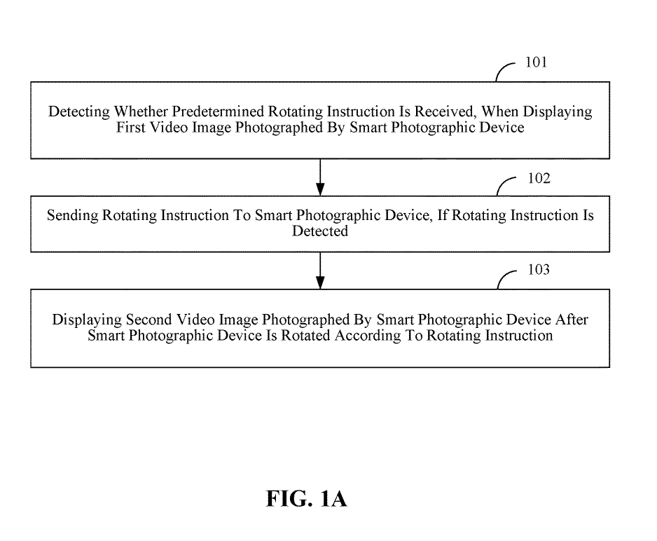

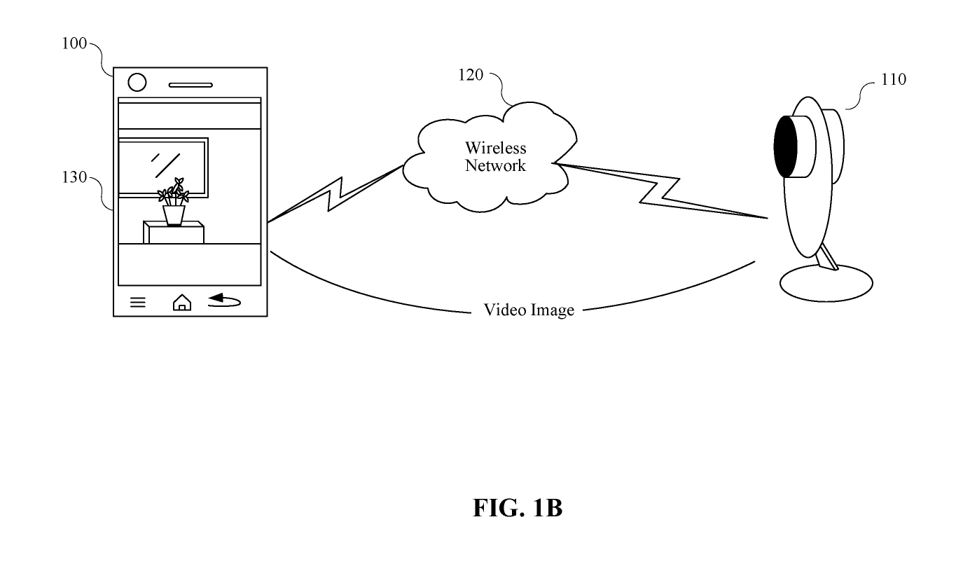

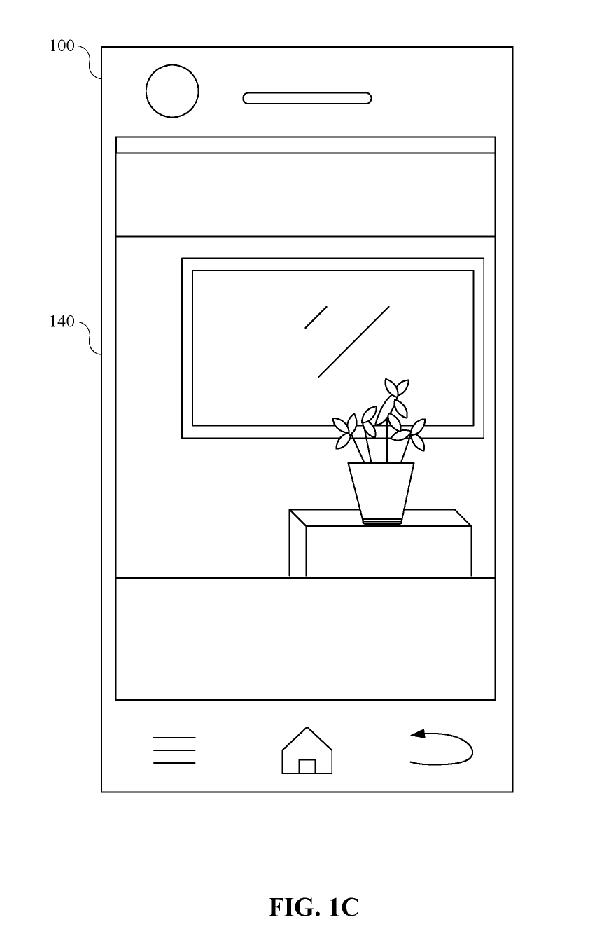

FIG. 1A is a flow chart showing a method for controlling a video image, according to an example embodiment. The method is applied on a smart terminal associated with a smart photographic device and includes the following steps.

In step 101, the smart terminal detects whether a predetermined rotating instruction is received, when displaying a first video image photographed by the smart photographic device.

The smart photographic device involved in embodiments of the present disclosure can be a smart device having a video shooting function and a wireless network access function. The smart photographic device can be disposed at any site where a monitoring demand is needed. The smart photographic device generally includes a camera and a cradle head driving the camera to rotate.

The smart terminal involved in embodiments of the present disclosure can be a smart device having a wireless network access function and a video playing function, for example, a portable terminal such as a smart phone, a panel computer, a PDA (Personal Digital Assistant), etc.

The smart terminal can establish an association with the smart photographic device in advance. If the smart terminal and the smart photographic device are connected to a network respectively, the smart terminal can establish a wireless connection with the smart photographic device, and then receives the video image transmitted by the smart photographic device via the wireless connection. The smart photographic device can transmit the video image photographed in real time to the smart terminal after the wireless connection with the smart terminal is established.

In step 102, the smart terminal sends the rotating instruction to the smart photographic device, if the rotating instruction is detected.

After acquiring the video image from the smart photographic device, the smart terminal displays the video image on a display screen of the smart terminal for a user of the smart terminal to view. FIG. 1B is a schematic diagram showing a common application scene according to an embodiment. As shown in FIG. 1B, a smart terminal 100 is implemented by a mobile phone, and a smart photographic device 110 is implemented by a web camera. The user installs the smart photographic device 110 in a living room of his/her home, and can remotely monitor the living room by using the smart terminal 100 to receive a video image 130 transmitted by the smart photographic device 110 via a wireless connection through a wireless network 120. Generally, a shooting angle of the smart photographic device 110 is limited, for example, between 110° to 180°. For example, as shown in FIG. 1B, the smart photographic device 110 includes the web camera and a cradle head installed below the web camera. A wide angle of the web camera is 110°. Therefore, if the web camera is fixed at a certain location for collecting the video image 130, it may be known from the video image 130 displayed by the smart terminal 100 in FIG. 1B that the monitoring range of the web camera is limited.

In the embodiment of the present disclosure, the user can input the rotating instruction into the smart terminal. When receiving the rotating instruction, the smart terminal can send the rotating instruction to the smart photographic device, and the smart photographic device can rotate the cradle head to drive the camera to rotate according to the rotating instruction. Therefore, due to a rotation of the camera, video images within a larger range can be photographed and returned to the smart terminal for displaying on the display screen of the smart terminal, thus increasing the monitoring range and improving the user experience.

FIG. 1C is a schematic diagram showing the smart terminal 100 displaying a video image 140 according to one embodiment. Compared with the schematic diagram of the smart terminal 100 in FIG. 1B, it may be known that FIG. 1C shows the video image 140 photographed by the camera after rotation, thus increasing the monitoring range.

In one embodiment, detecting whether a predetermined rotating instruction is received, when displaying a first video image photographed by the smart photographic device, includes: outputting a rotation option at a first predetermined location of a user interface displaying the first video image; and determining that the predetermined rotating instruction is received, if a predetermined first touch event is received via the rotation option.

The first predetermined location can be any location on the user interface displaying the first video image, for instance, a midpoint position at each of four edges of the user interface, or a vertex position of the user interface.

The rotation option can include one or more options, and can be displayed in a form of an icon or a choice box. When the user clicks the icon or the choice box, it is determined that the rotating instruction is received.

The first touch event can be a single-click event, a double-click event, or a press-and-hold event, etc.

The first predetermined location, the rotation option, and the first touch event mentioned above can be flexibly configured by those skilled in the art according to actual demands, which are not limited in this embodiment.

With the above embodiment of the present disclosure, since the rotation option is displayed in the video image, by receiving the touch event inputted by the user via the rotation option, it may be quickly determined that the rotating instruction is received. In this way, it may be convenient for the user to input the rotating instruction, such that the user's operation is simplified and the user experience is improved.

In one embodiment, outputting a rotation option at a first predetermined location of a user interface displaying the first video image includes: detecting whether a predetermined second touch event is received at a second predetermined location of the user interface; and outputting the rotation option at the first predetermined location of the user interface, if the second touch event is received.

The second predetermined location can be any location on the user interface displaying the first video image, for instance, a midpoint of the user interface, or a position in the central region of the user interface or the like.

The second touch event can be a single-click event, a double-click event, or a press-and-hold event, etc.

The second predetermined location and the second touch event can be flexibly configured by those skilled in the art according to actual demands, which are not limited in the embodiment.

In the embodiment above, the user interface can display only the video image, and output the rotation option for the users to select only when the predetermined second touch event is received at the second predetermined location of the user interface, that is, when the user needs to input the rotating instruction. Therefore, a full video image is displayed when the user does not need to input the rotating instruction, thus improving a displaying effect of the video image.

In one embodiment, it is detected whether a predetermined third touch event is received at a third predetermined location of the user interface, after outputting the rotation option. If the third touch event is received, the rotation option is hidden.

The third predetermined location can be any location on the user interface displaying video images, for instance, a midpoint of the user interface, or a position in the central region of the user interface or the like.

The third touch event can be a single-click event, a double-click event, or a press-and-hold event, etc.

The third predetermined location and the third touch event mentioned above can be flexibly configured by those skilled in the art, which are not limited in the embodiment.

In the embodiment above, after the user inputs the rotating instruction, the user may trigger the third touch event. Once the smart terminal detects the third touch event, the smart terminal hides the rotation option, such that the full video image can be displayed, thus improving the displaying effect of the video image.

In one embodiment, determining that the rotating instruction is received, includes: determining that the rotating instruction received is a rotating instruction for rotating the smart photographic device by a predetermined angle in a predetermined direction, if the first touch event is a single-click event; and determining that the rotating instruction received is a rotating instruction for rotating the smart photographic device continuously in a predetermined direction, if the first touch event is a press-and-hold event.

In the embodiment above, if the user single-clicks the rotation option, the smart terminal detects the single-click event, then the smart device determines that the rotating instruction received is a rotating instruction for rotating the smart photographic device by a predetermined angle in a predetermined direction; and if the user presses and holds the rotation option, the smart terminal detects the press-and-hold event, then the smart device determines that the rotating instruction received is a rotating instruction for rotating the smart photographic device continuously in a predetermined direction. In this way, it may be convenient for the user to adjust the rotation angle of the smart photographic device, thus simplifying the user's operation and improving the user experience.

Referring to FIG. 1A, in step 103, the smart terminal displays a second video image photographed by the smart photographic device after the smart photographic device is rotated according to the rotating instruction.

After the smart photographic device is rotated according to the rotating instruction, a shooting range of the smart photographic device is changed, and the video image photographed by the smart photographic device after rotation is sent to the smart photographic device for display, thus increasing the monitoring range of the smart photographic device and improving the user experience.

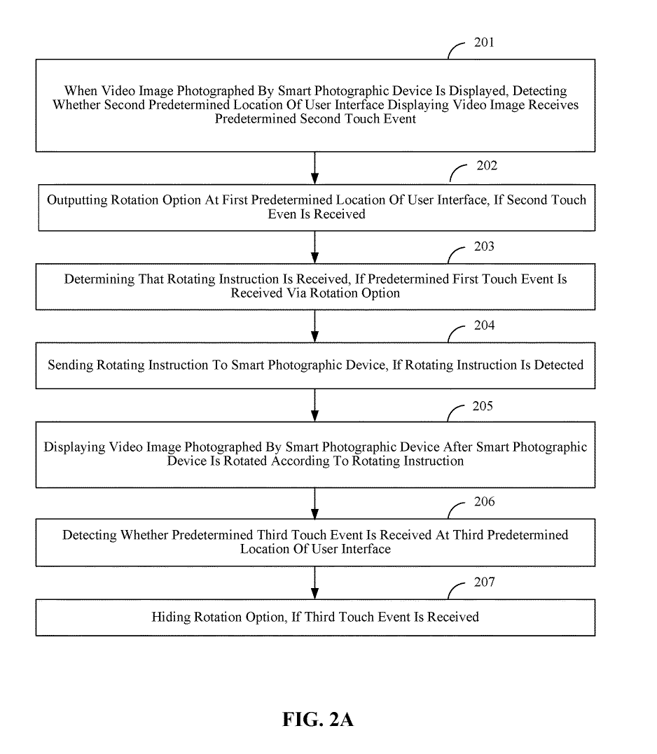

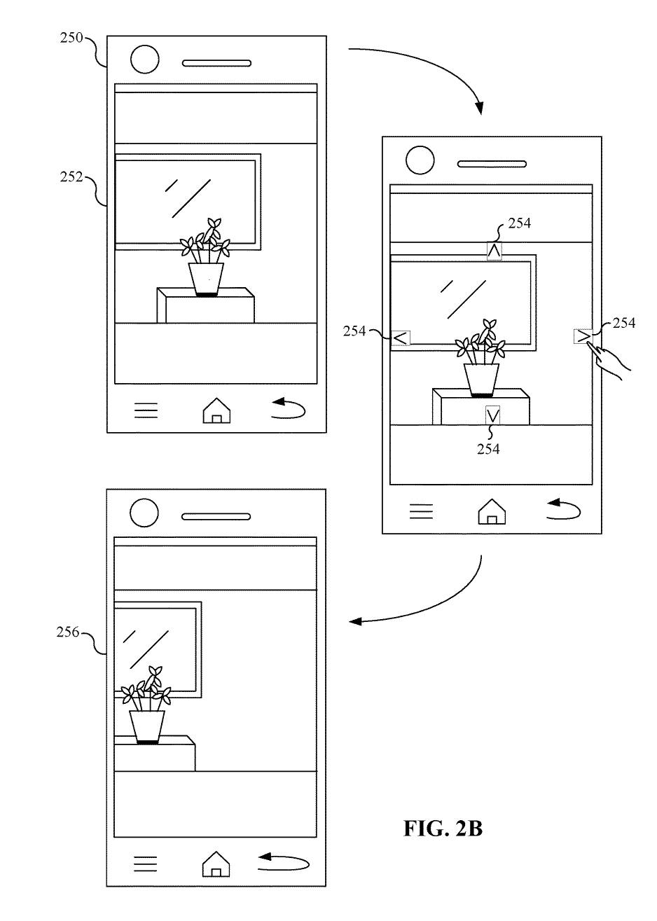

FIG. 2A is a flow chart showing another method for controlling a video image, according to an example embodiment. The method is applied on a smart terminal associated with a smart photographic device. The method includes the following steps.

In step 201, when a video image photographed by the smart photographic device is displayed by the smart terminal, the smart terminal detects whether a second predetermined location of a user interface displaying the video image receives a predetermined second touch event.

In step 202, the smart terminal outputs a rotation option at a first predetermined location of the user interface, if the second touch event is received.

In step 203, the smart terminal determines that a rotating instruction is received, if a predetermined first touch event is received via the rotation option.

In step 204, the smart terminal sends the rotating instruction to the smart photographic device, if the rotating instruction is detected.

In step 205, the smart terminal displays a video image photographed by the smart photographic device after the smart photographic device is rotated according to the rotating instruction.

In step 206, the smart terminal detects whether a predetermined third touch event is received at a third predetermined location of the user interface.

In step 207, the smart terminal hides the rotation option, if the third touch event is received.

For example, FIG. 2B is a schematic diagram showing a smart terminal 250 displaying a video image 252 according to the present disclosure. In FIG. 2B, the smart terminal 250 displays the video image 252 currently photographed by a camera. If the user clicks a center of the video image 252, the smart terminal 250 receives the second touch event, and a rotation option 254 is outputted at a midpoint position at each of four edges of the user interface displaying video image 252. Thus, four rotation options are outputted on the user interface. The four rotation options 254 are shown in the form of icons in the figure, and these four icons respectively correspond to the upward, downward, leftward, and rightward rotation directions. If the user single-clicks the rightward icon, the smart terminal 250 receives the first touch event, determines that the rotating instruction is received, and sends the rotating instruction to a smart photographic device. Once receiving the rotating instruction, the smart photographic device controls a cradle head connected to the camera to rotate so as to drive the camera to rotate by a predetermined angle, and the camera outputs a video image 256 photographed to the smart terminal 250. If the user does not need to input the rotating instruction, the user clicks the center of the video image, and the smart terminal 250 receives the third touch event, and then hides the rotation options 254. In this way, the user interface does not display the rotation option, such that the displaying effect of the video image is better.

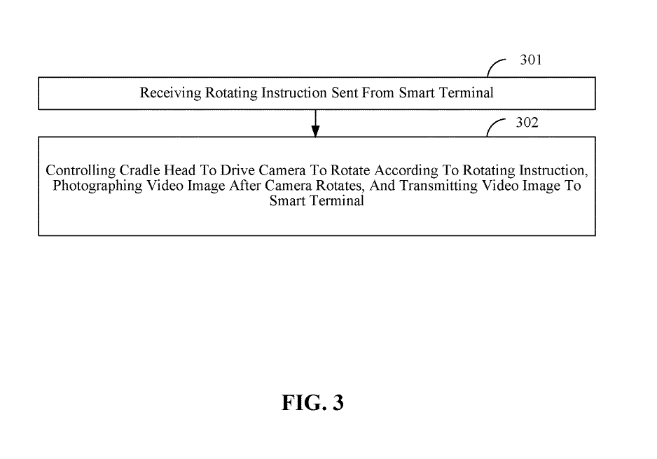

FIG. 3 is a flow chart showing a method for controlling a video image, according to an example embodiment. The method is applied on a smart photographic device. The smart photographic device includes a cradle head and a camera. The method includes the following steps.

In step 301, the smart photographic device receives a rotating instruction sent from a smart terminal.

In step 302, the smart photographic device controls the cradle head to drive the camera to rotate according to the rotating instruction, photographs a video image after the camera is rotated according to the rotating instruction, and transmits the photographed video image to the smart terminal.

In this embodiment, the camera can be installed on the cradle head, and the cradle head can rotate in any direction and by any angle. If the rotating instruction sent by the smart terminal is received, the cradle head can be controlled to drive the camera to rotate according to the rotating instruction, and the video image is photographed after rotation and is returned to the smart terminal. Since the camera can photograph video images within a larger range after rotation, a monitoring range is increased.

In one embodiment, controlling the cradle head to drive the camera to rotate according to the rotating instruction, includes: controlling the cradle head to drive the camera to rotate by a predetermined angle in a predetermined direction; or controlling the cradle head to drive the camera to continuously rotate in a predetermined direction.

The predetermined direction can be any direction, such as a horizontally leftward or vertically upward direction, and the predetermined angle can be 10°, 12°, or 15°. With the above two manners for rotating the camera, the user can enable the smart photographic device to rotate by the predetermined angle in the predetermined direction when requiring the smart photographic device to rotate within a smaller range, and can also enable the smart photographic device to continuously rotate when requiring the smart photographic device to rotate within a larger range, such that the monitoring range is changed quickly and the user experience is enhanced.

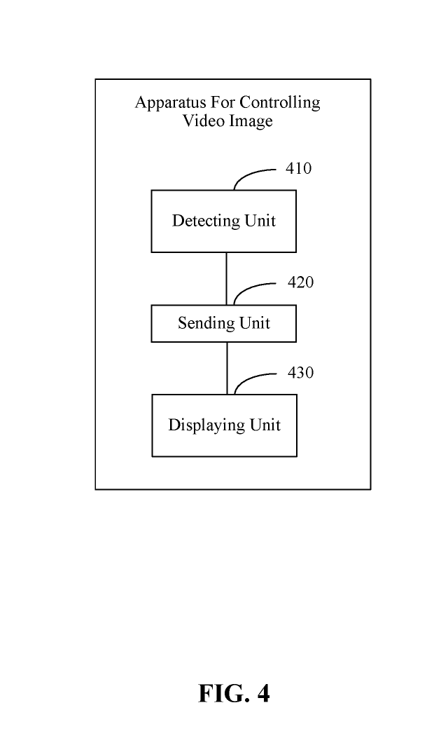

FIG. 4 is a block diagram of an apparatus for controlling a video image, according to an example embodiment. The apparatus is applied on a smart terminal associated with a smart photographic device. The apparatus includes: a detecting unit 410, a sending unit 420, and a displaying unit 430.

The detecting unit 410 is configured to detect whether a predetermined rotating instruction is received, when displaying a first video image photographed by the smart photographic device.

The sending unit 420 is configured to send the rotating instruction to the smart photographic device, if the rotating instruction is detected.

The displaying unit 430 is configured to display a second video image photographed by the smart photographic device after the smart photographic device is rotated according to the rotating instruction.

It may be known from the embodiments above that, with the present disclosure, when displaying a video image, if the predetermined rotating instruction is received, the rotating instruction is sent to the smart photographic device, and the smart photographic device rotates according to the rotating instruction. Because the smart photographic device can take video images within different ranges after rotation, a coverage of the video image can be expanded, thus improving a user experience.

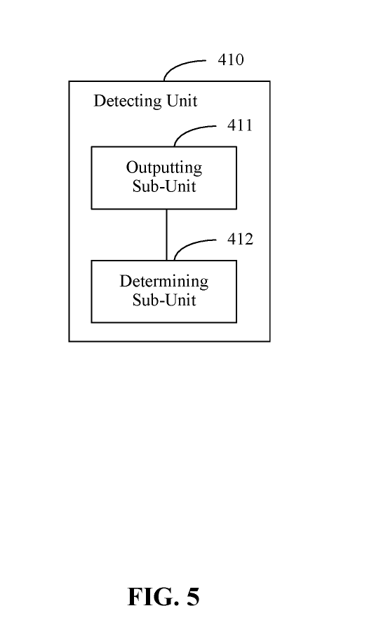

FIG. 5 is a block diagram of an apparatus for controlling a video image, according to an example embodiment. Based on the embodiment of FIG. 4, the detecting unit 410 in this embodiment includes: an outputting sub-unit 411 and a determining sub-unit 412.

The outputting sub-unit 411 is configured to output a rotation option at a first predetermined location of a user interface displaying the first video image.

The determining sub-unit 412 is configured to determine that the rotation instruction is received, if a predetermined first touch event is received via the rotation option.

It may be known from the embodiments above that, with the present disclosure, since the rotation option is displayed in the video image, by receiving the first touch event inputted by the user via the rotation option, it may be quickly determined that the rotating instruction is received. In this way, it may be convenient for the user to input the rotating instruction, such that the user's operation is simplified and the user experience is improved.

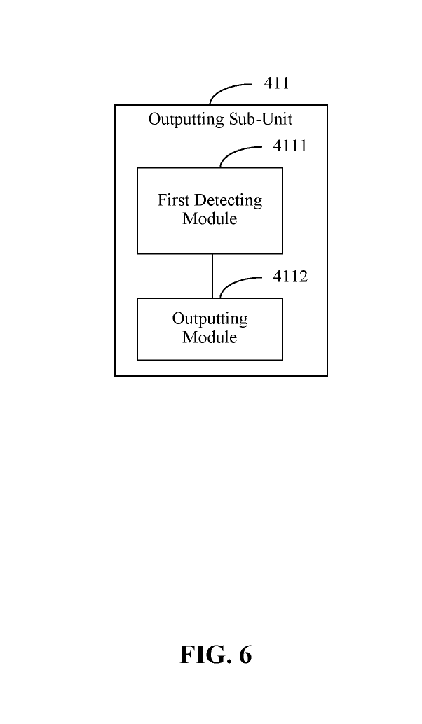

FIG. 6 is a block diagram of an apparatus for controlling a video image, according to an example embodiment. Based on the embodiment of FIG. 4, the outputting sub-unit 411 in this embodiment includes: a first detecting module 4111 and an outputting module 4112.

The first detecting module 4111 is configured to detect whether a predetermined second touch event is received at a second predetermined location of the user interface.

The outputting module 4112 is configured to output the rotation option at the first predetermined location of the user interface, if the second touch event is received.

It may be known from the embodiments above that, with the present disclosure, the user interface can display only the video image, and output the rotation option for the user to select if the predetermined second touch event is received at the second predetermined location of the user interface, that is, when the user needs to input the rotating instruction. Therefore, a full video image is displayed if the user does not need to input the rotating instruction, thus improving a displaying effect of the video image.

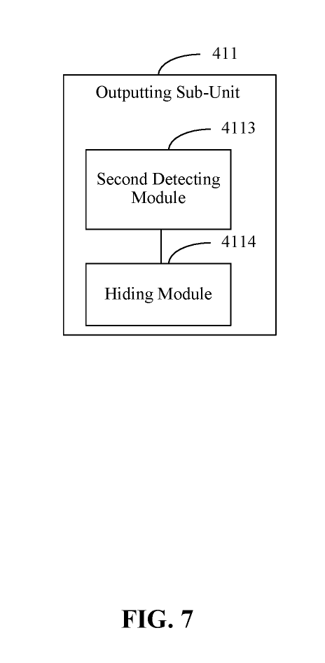

FIG. 7 is a block diagram of an apparatus for controlling a video image, according to an example embodiment. Based on the embodiment of FIG. 4, the outputting sub-unit 411 in this embodiment further includes: a second detecting module 4113 and a hiding module 4114.

The second detecting module 4113 is configured to detect whether a predetermined third touch event is received at a third predetermined location of the user interface.

The hiding module 4114 is configured to hide the rotation option, if the third touch event is received.

It may be known from the embodiments above that, with the present disclosure, after the user inputs the rotating instruction, the user may trigger the third touch event. Once the smart terminal detects the third touch event, the smart terminal hides the rotation option displayed, such that the full video image can be displayed, thus improving the displaying effect of the video image.

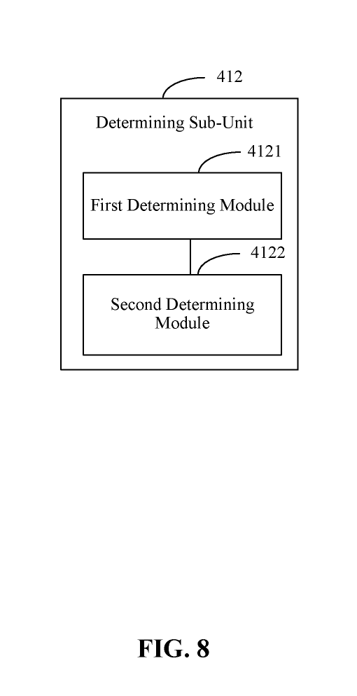

FIG. 8 is a block diagram of an apparatus for controlling a video image, according to an example embodiment. Based on the embodiment of FIG. 4, the determining sub-unit 412 in this embodiment further includes a first determining module 4121 and a second determining module 4122.

The first determining module 4121 is configured to determine that the rotating instruction received is a rotating instruction for rotating the smart photographic device by a predetermined angle in a predetermined direction, if the first touch event is a single-click event.

The second determining module 4122 is configured to determine that the rotating instruction received is a rotating instruction for rotating the smart photographic device continuously in a predetermined direction, if the first touch event is a press-and-hold event.

It may be known from the embodiments above that, with the present disclosure, if the user single-clicks the rotation option, the smart terminal detects the single-click event, then it is determined that the rotating instruction received is a rotating instruction for rotating the smart photographic device by a predetermined angle in a predetermined direction; and if the user presses and holds the rotation option, the smart terminal detects the press-and-hold event, then it is determined that the rotating instruction received is a rotating instruction for rotating the smart photographic device continuously in a predetermined direction. In this way, it may be convenient for the user to adjust the rotation angle of the smart photographic device, thus simplifying the user's operation and improving the user experience.

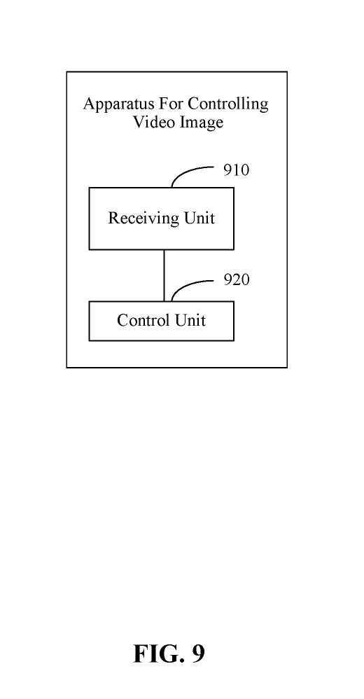

FIG. 9 is a block diagram of an apparatus for controlling a video image, according to an example embodiment. The apparatus is applied on a smart photographic device, and the smart photographic device includes a cradle head and a camera. The apparatus includes: a receiving unit 910 and a control unit 920.

The receiving unit 910 is configured to receive a rotating instruction sent from a smart terminal.

The control unit 920 is configured to control the cradle head to drive the camera to rotate according to the rotating instruction, to photograph a video image after the rotation, and to transmit the video image to the smart terminal.

It may be known from the embodiments above that, with the present disclosure, the camera can be installed on the cradle head, and the cradle head can rotate in any direction and by any angle. If the rotating instruction sent by the smart terminal is received, the cradle head can be controlled to drive the camera to rotate according to the rotating instruction, and the video image is taken after rotation and is returned to the smart terminal. Since the camera can take video images within a larger range after rotation, a monitoring range is increased.

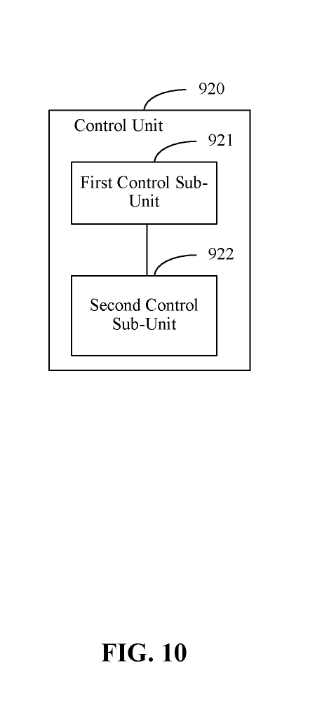

FIG. 10 is a block diagram of an apparatus for controlling a video image, according to an example embodiment. Based on the embodiment of FIG. 9, the control unit 920 in this embodiment includes a first control sub-unit 921 and a second control sub-unit 922.

The first control sub-unit 921 is configured to control the cradle head to drive the camera to rotate by a predetermined angle in a predetermined direction.

The second control sub-unit 922 is configured to control the cradle head to drive the camera to continuously rotate in a predetermined direction.

With the present disclosure, the user can enable the smart photographic device to rotate by the predetermined angle in the predetermined direction when requiring the smart photographic device to rotate within a smaller range, and can also enable the smart photographic device to continuously rotate when requiring the smart photographic device to rotate within a larger range, such that the monitoring range is changed quickly and the user experience is enhanced.

With respect to the apparatuses in the above embodiments, the specific manners for performing operations for individual units therein have been described in detail in the embodiments regarding the methods above, which will not be elaborated herein.

Embodiments of the devices correspond to embodiments of the methods. For a related content, reference is made to partial descriptions of the embodiments of the methods. The above embodiments of the devices are exemplary. Units described as separate components may be or may not be physically separated. Components shown as units may be or may not be physical units, in other words, may be integrated on one position or distributed to a plurality of network units. Some or all of the modules may be selected to achieve the objective of the solution of the embodiments according to actual requirements. Those skilled in the art may understand and implement the present disclosure without making creative efforts.

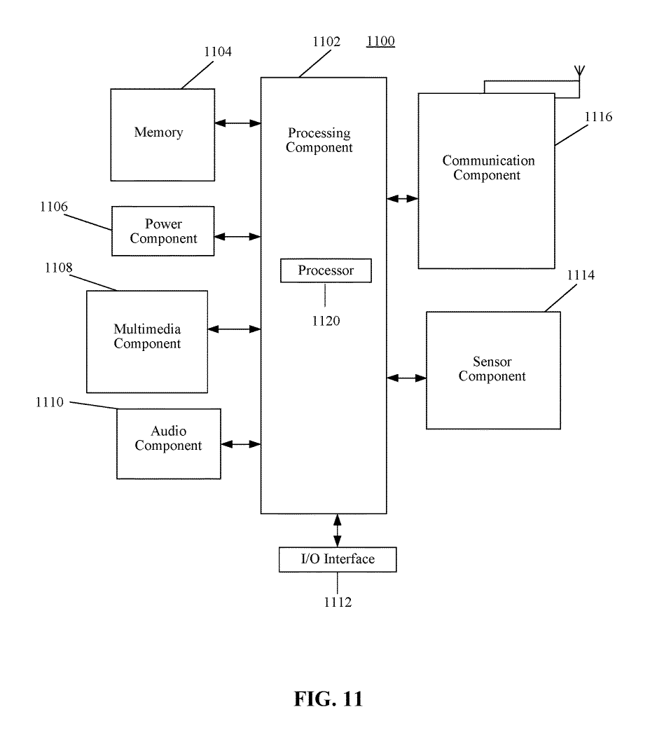

FIG. 11 is a block diagram of a device for controlling a video image, according to an example embodiment. For example, the device 1100 may be a mobile phone, a computer, a digital broadcast terminal, a messaging device, a gaming console, a tablet, a medical device, exercise equipment, a personal digital assistant, and the like.

Referring to FIG. 11, the device 1100 includes one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls overall operations of the device 1100, such as the operations associated with display, telephone calls, data communications, camera operations, and recording operations. The processing component 1102 may include one or more processors 1120 to execute instructions to perform all or part of the steps in the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the device 1100. Examples of such data include instructions for any applications or methods operated on the device 1100, contact data, phonebook data, messages, pictures, video, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the device 1100. The power component 1106 may include a power management system, one or more power sources, and any other components associated with the generation, management, and distribution of power in the device 1100.

The multimedia component 1108 includes a screen providing an output interface between the device 1100 and the user. In some embodiments, the screen may include a liquid crystal display and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 includes a front camera and/or a rear camera. The front camera and the rear camera may receive an external multimedia datum while the device 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone configured to receive an external audio signal when the device 1100 is in an operation mode, such as a call mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1114 includes one or more sensors to provide status assessments of various aspects of the device 1100. For instance, the sensor component 1114 may detect an open/closed status of the device 1100, relative positioning of components, e.g., the display and the keypad, of the device 1100, a change in position of the device 1100 or a component of the device 1100, a presence or absence of user contact with the device 1100, an orientation or an acceleration/deceleration of the device 1100, and a change in temperature of the device 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate communication, wired or wirelessly, between the device 1100 and other devices. The device 1100 can access a wireless network based on a communication standard, such as WiFi, 2G; 3G; or 4G; or a combination thereof. In one exemplary embodiment, the communication component 1116 receives a broadcast signal or broadcast associated information from an external broadcast management system via a broadcast channel. In one exemplary embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the device 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1104, executable by the processor 1120 in the device 1100, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of submodules/subunits.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for controlling a video image, applied on a smart terminal associated with a smart photographic device, comprising:
detecting whether a predetermined rotating instruction is received, when displaying a first video image photographed by the smart photographic device;
sending the predetermined rotating instruction to the smart photographic device, if the predetermined rotating instruction is detected; and
displaying a second video image photographed by the smart photographic device after the smart photographic device is rotated according to the predetermined rotating instruction.

2. The method according to claim 1, wherein detecting whether a predetermined rotating instruction is received, when displaying a first video image photographed by the smart photographic device comprises:
outputting a rotation option at a first predetermined location of a user interface displaying the first video image; and
determining that the predetermined rotating instruction is received, if a predetermined first touch event is received via the rotation option.

3. The method according to claim 2, wherein outputting a rotation option at a first predetermined location of a user interface displaying the first video image comprises:
detecting whether a predetermined second touch event is received at a second predetermined location of the user interface; and
outputting the rotation option at the first predetermined location of the user interface, if the predetermined second touch event is received.

4. The method according to claim 3, further comprising:
detecting whether a predetermined third touch event is received at a third predetermined location of the user interface, after outputting the rotation option; and
hiding the rotation option, if the predetermined third touch event is received.

5. The method according to claim 2, wherein determining that the predetermined rotating instruction is received comprises:
determining that the predetermined rotating instruction received is a rotating instruction for rotating the smart photographic device by a predetermined angle in a predetermined direction, if the predetermined first touch event is a single-click event;
determining that the predetermined rotating instruction received is a rotating instruction for rotating the smart photographic device continuously in the predetermined direction, if the predetermined first touch event is a press-and-hold event.

6. A method for controlling a video image, applied on a smart photographic device, the smart photographic device comprising a cradle head and a camera, the method comprising:
receiving a rotating instruction sent from a smart terminal; and
controlling the cradle head to drive the camera to rotate according to the rotating instruction, photographing a video image after the camera is rotated according to the rotating instruction, and transmitting the video image to the smart terminal.

7. The method according to claim 6, wherein controlling the cradle head to drive the camera to rotate according to the rotating instruction comprises:
controlling the cradle head to drive the camera to rotate by a predetermined angle in a predetermined direction.

8. The method according to claim 6, wherein controlling the cradle head to drive the camera to rotate according to the rotating instruction comprises:
controlling the cradle head to drive the camera to continuously rotate in a predetermined direction.

9. An apparatus for controlling a video image, applied on a smart terminal associated with a smart photographic device, comprising:
a processor; and
a memory for storing instructions executable by the processor;
wherein when executing the instructions stored in the memory, the processor is configured to:
detect whether a predetermined rotating instruction is received, when displaying a first video image photographed by the smart photographic device;
send the predetermined rotating instruction to the smart photographic device, if the predetermined rotating instruction is detected; and
display a second video image photographed by the smart photographic device after the smart photographic device is rotated according to the predetermined rotating instruction.

10. The apparatus according to claim 9, wherein the processor is configured to detect whether a predetermined rotating instruction is received when displaying a first video image photographed by the smart photographic device by:
outputting a rotation option at a first predetermined location of a user interface displaying the first video image; and
determining that the predetermined rotating instruction is received, if a predetermined first touch event is received via the rotation option.

11. The apparatus according to claim 10, wherein the processor is configured to output a rotation option at a first predetermined location of a user interface displaying the first video image by:
detecting whether a predetermined second touch event is received at a second predetermined location of the user interface; and
outputting the rotation option at the first predetermined location of the user interface, if the predetermined second touch event is received.

12. The apparatus according to claim 11, wherein the processor is further configured to:
detect whether a predetermined third touch event is received at a third predetermined location of the user interface; and
hide the rotation option, if the predetermined third touch event is received.

13. The apparatus according to claim 10, wherein the processor is configured to determine that the predetermined rotating instruction is received by:
determining that the predetermined rotating instruction received is a rotating instruction for rotating the smart photographic device by a predetermined angle in a predetermined direction, if the predetermined first touch event is a single-click event;
determining that the predetermined rotating instruction received is a rotating instruction for rotating the smart photographic device continuously in the predetermined direction, if the predetermined first touch event is a press-and-hold event.
